(19) United States
(12) Patent Application Publication
(10) Pub. No.: US 2021/0032893 A1
(43) Pub. Date: Feb. 4, 2021

(54) HUNTING BLIND APPARATUS AND METHOD

(71) Applicant: William C. Allbee, Muskego, WI (US)

(72) Inventor: William C. Allbee, Muskego, WI (US)

(21) Appl. No.: 16/943,420

(22) Filed: Jul. 30, 2020

Related U.S. Application Data
(60) Provisional application No. 62/922,259, filed on Jul. 30, 2019.

(51) Int. Cl. E04H 15/00

(52) U.S. Cl. CPC E04H 15/001; E04H 15/56; E04H 15/008

(57) ABSTRACT

A hunting blind including four side panels and a roof panel. The four side panels and the roof panel include perforated peripheral frame members. The perforations in the frame members are aligned so that pins can be inserted through the perforations and retained there through so that the side panels and the roof panel are fastened together to form the hunting blind. The hunting blind is preferably bolted to a floor panel which floor panel can be mounted on a stand to elevate the hunting blind.

### CROSS-REFERENCE TO RELATED APPLICATION

This application claims the benefit of U.S. Provisional Application No. 62/922,259, filed Jul. 30, 2019, and which is hereby incorporated by reference in its entirety.

### TECHNICAL FIELD

This disclosure relates to hunting blinds.

### BACKGROUND

Hunting blinds are often used by hunters to provide shelter and to conceal themselves to avoid detection by game animals. Hunting blinds are typically either permanent structures or are similar to tents. Permanent structure hunting blinds are more durable and weather resistant than tent type hunting blinds but are time consuming to construct and are not suitable for hunting locations that do not permit permanent structures. Tent type hunting blinds can be erected as easily as a camping tent, but lack the durability and weather resistance of permanent structure hunting blinds.

### SUMMARY

A hunting blind includes four rigid side panels and a rigid roof panel. Each of the four side panels and the roof panel define peripheral apertures. The hunting blind further includes a plurality of pins. The side panels and the roof panel are arranged such that each of the side panels is connected to two other side panels and the roof panel by two connections, namely one of the pins extending through one of the apertures in one of the panels and another of the apertures in another of the panels. Clips may be inserted through holes in the pins to prevent their removal from the apertures in the panels.

The hunting blind provided herein combines the weather resistance and durability of a permanent hunting blind with the ease of transport and erection of many tent type hunting blinds. More specifically, the connections with the pins permit the panels to be separated from each other for ease of transport. The connections also provide rapid and easy assembly of the panels into a hunting blind because the pins may be rapidly inserted with a single motion and do not require any tools.

A corresponding method of assembly and kit of parts are also provided herein.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, front, perspective view of a hunting blind having four side panels, a roof panel, and a plurality of pins in accordance with the claimed invention;

FIG. 2 is a schematic, rear, perspective view of the hunting blind attached to an elevated stand;

FIG. 3 is a schematic, perspective view of the hunting blind and elevated stand in a disassembled state;

FIG. 4 is a schematic, perspective view of a portion of the interior of the hunting blind;

FIG. 5 is a schematic, side view of a pin used to assemble the hunting stand;

FIG. 6 is a schematic, cross-sectional side view of the floor and a side panel of the hunting blind;

FIG. 7 is a schematic, cross-sectional view of a connection between a side panel and another side panel; and

FIG. 8 is a schematic, cross-sectional view of a connection between a side panel and the roof panel.

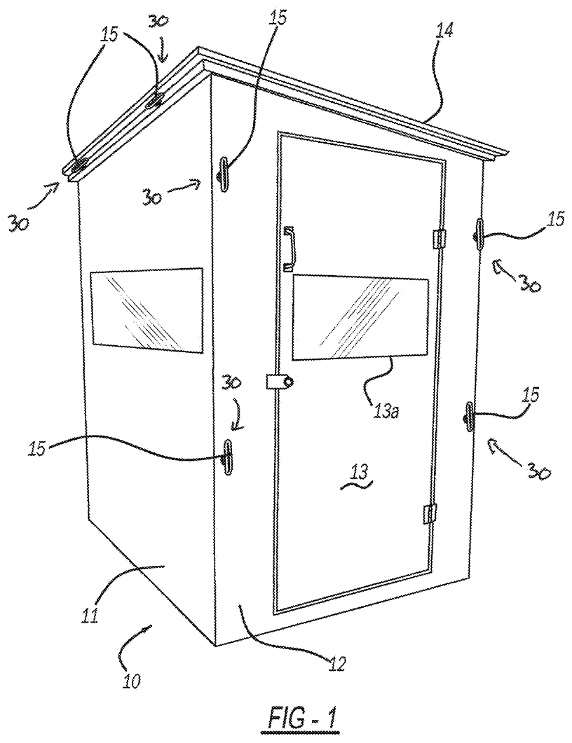

### DESCRIPTION OF THE PREFERRED EMBODIMENTS

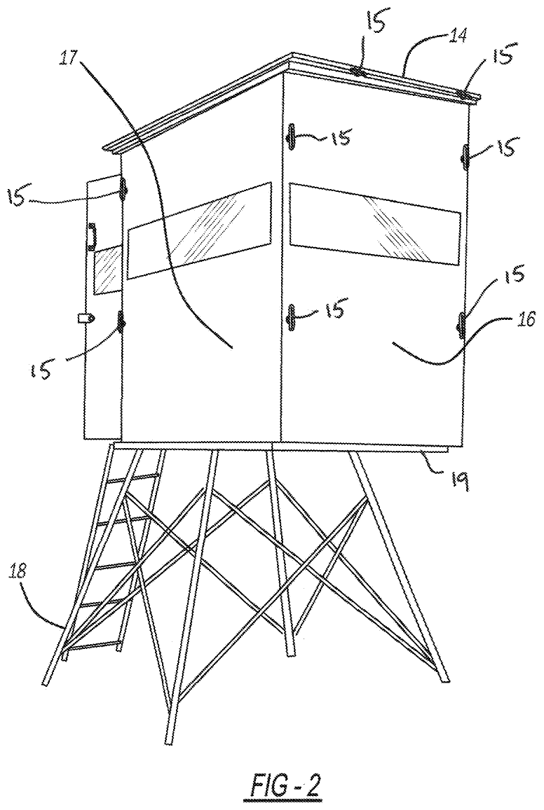

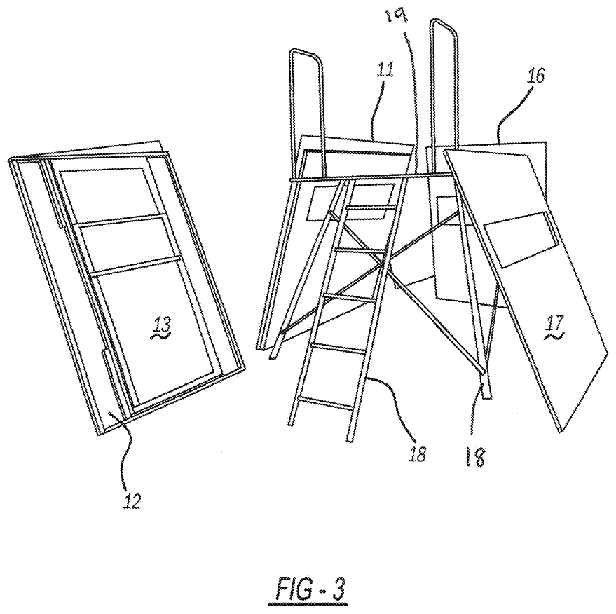

Referring the Figures, wherein like reference numbers refer to like components throughout, therein is shown a hunting blind 10. The blind 10 includes a first side panel 11, a second side panel 12, a third side panel 16, a fourth side panel 17, and a roof panel 14. The second side panel 12 forms the front of the blind 10 and includes a door 13 and polycarbonate window 13a. Pins 15 (shown inserted from the outside of blind 10 in this view) are used to attach the wall panels 11, 12, 16, 17 and the roof panel 14 together as discussed below. As shown in FIG. 2, the blind 10 is connectable to a floor panel and positioned on elevated stand 18.

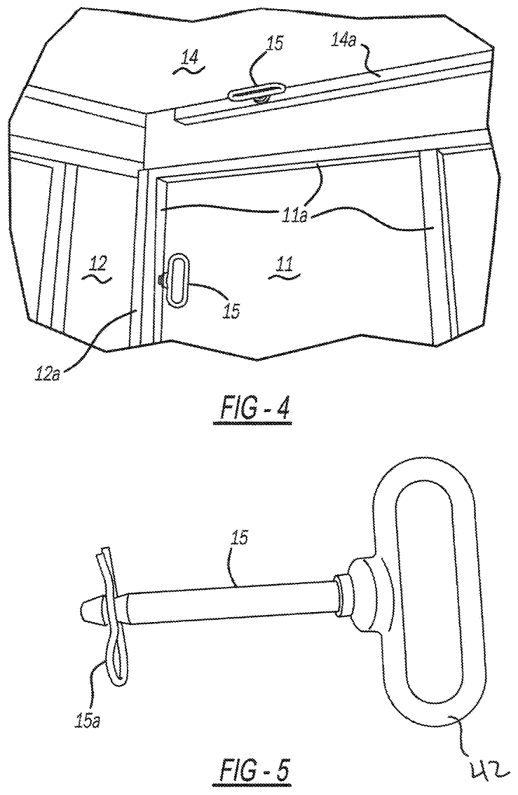

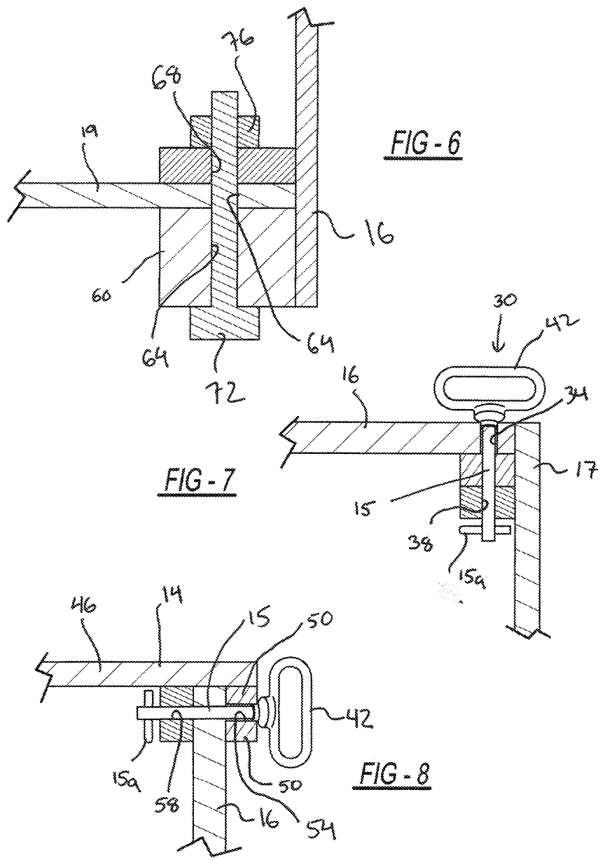

Referring now to FIG. 4 therein is shown an interior view of blind 10: side panel 11 is comprised of peripheral frame member 11a; side panel 12 is comprised of peripheral frame member 12a; and roof panel 14 is comprised of peripheral frame member 14a. The peripheral frame members of the panels are perforated and the perforations are aligned so that pins 15 can be inserted through the perforations and retained there through so that the side panels and the roof panel are fastened together to form blind 10. Referring now to FIG. 5, therein is shown a highly preferred pin 15 of the instant invention including retaining clip 15a. Referring now to FIG. 6, therein is shown an interior view of blind 10 bolted to floor panel 19 by lag bolts 20 through lower peripheral frame members 17a in side panel 17 and lower peripheral frame member 16a of rear panel 16.

The components of the instant invention can be made of any suitable material. The side and roof panels are preferably ⅜ inch strand board (OSB) painted with high quality exterior paint. The peripheral frame members are preferably 2×2 wood. The floor panel is preferably a sheet of waterproof plywood preferably covered with marine grade carpeting to dampen sound. The windows of the blind are preferably polycarbonate to provide a 360 degree view from the inside of the blind.

The blind of the instant invention can be assembled or disassembled in 15 minutes. The only tool needed is a wrench to bolt the blind to the floor panel. The side and roof panels are held together by the pins. The panels are light weight and easily transported. The assembled blind is sturdy and durable

Thus, the hunting blind 10 includes four rigid side panels 11, 12, 16, 17 and a rigid roof panel 14. Each of the four side panels 11, 12, 16, 17 and the roof panel 14 define peripheral plurality of peripheral apertures. The hunting blind 10 also includes a plurality of pins 15. The side panels 11, 12, 16, 17 and roof panel 14 are arranged such that each of the side panels 11, 12, 16, 17 is connected to two other side panels and the roof panel 14 by two connections 30. Each of the connections 30 is one of the pins 15 extending through one of the apertures in one of the panels 11, 12, 14, 16, 17 and another of the apertures in another of the panels 11, 12, 14, 16, 17.

FIG. 7 is a schematic, cross-sectional view taken about a horizontal plane of one of the connections 30 connecting panel 16 and panel 17. The connection 30 shown in FIG. 7, including the apertures defined by panels 16 and 17, is substantially identical to the other connections, and is thus representative of all connections between the four side panels 11, 12, 16, 17. Referring to FIG. 7, panel 16 defines aperture 34 and panel 17 defines aperture 38. As shown in FIG. 7, aperture 38 of panel 17 is formed in a peripheral frame member attached to the main panel portion. One of the pins 15 extends through the aperture 34 of panel 16 and through aperture 38 of panel 17. The connection 30 also includes a clip 15a extending through a hole defined by the pin 15.

Thus, the panel 16 is connected to panel 17 at a ninety degree angle by connection 30. The handle 42 of the pin 15 prevents removal of the of the pin 15 in one direction, and the clip 15a prevents removal of the pin 15 in the other direction. Clip 15a is a cotter pin in the embodiment depicted.

In a similar manner, panel 11 is connected to panel 12 by two connections 30 and to panel 16 by two connections 30. Panel 16 is connected to panel 17 by two connections 30, and panel 17 is connected to panel 12 by two connections. The panels 11, 12, 16, 17 cooperate to define four walls of the hunting blind 10.

FIG. 8 is a schematic, cross-sectional view taken about a vertical plane of one of the connections 30 connecting panel 16 and the roof panel 14, which is representative of all connections 30 between the roof panel 14 and the side panels 11, 12, 16, 17. The roof panel 14 includes a horizontal panel portion 46 and vertically extending trim 50 that extends downward along the periphery of the panel 14. An aperture 54 is formed by the trim 50 of the roof panel 14, and is aligned with an aperture 58 in the side panel 16, including through the peripheral frame member of panel 16. One of the pins 15 extends through apertures 54 and 58 and a clip 15a is attached to the pin 15.

The side panels 11, 12, 16, 17 are connectable to the floor 19 as shown in FIG. 6, which is a schematic, cross-sectional view taken about a vertical plane. Referring to FIG. 6, the floor 19 may include reinforcing members 60. The floor 19 defines a plurality of apertures, one of which is shown at 64. A peripheral frame member of panel 16 defines aperture 68. A bolt 72 extends through both apertures 64, 68 and is secured with a nut 76. It should be noted that it may be desirable to insert the bolt into the apertures 64, 68 from above so that the head of the bolt rests on the floor 19. The nut 76 would then be easily engaged with the bolt 72 from underneath the floor 19.

The connection between panel 16 and the floor 19 is representative of all connections between the floor 19 and the other panels 11, 12, 17. Thus, the hunting blind 10 may include a floor 19 defining a plurality of apertures 64 and a plurality of bolts 72. Each of the bolts 72 extends through a respective one of the apertures 64 in the floor 19 and a respective one of the apertures 68 in one of the four side panels 11, 12, 16, 17.

While the best modes for carrying out the invention have been described in detail, those familiar with the art to which this invention relates will recognize various alternative designs and embodiments for practicing the invention within the scope of the appended claims.

1. A hunting blind comprising:
four rigid side panels and a rigid roof panel;
each of the four side panels and the roof panel defining peripheral apertures; and
a plurality of pins;
said side panels and roof panel being arranged such that each of the side panels is connected to two other side panels and the roof panel by two connections;
each of said connections being one of the pins extending through one of the apertures in one of the panels and another of the apertures in another of the panels.

2. The hunting blind of claim 1, wherein each of the pins defines a respective hole; and
wherein each of said connections includes a clip extending through a hole in the pin.

3. The hunting blind of claim 2, wherein each of said pins includes a handle.

4. The hunting blind of claim 2, further comprising a floor defining a plurality of apertures;
a plurality of bolts; each of said bolts extending through a respective one of the apertures in the floor and a respective one of the apertures in one of the four side panels.

5. The hunting blind of claim 4, further comprising a plurality of nuts engaged with said plurality of bolts.

6. The hunting blind of claim 1, wherein at least one of said side panels includes a door.

7. The hunting blind of claim 6, wherein at least one of said side panels includes a window.

8. A method of assembling a hunting blind comprising:
possessing a kit of parts including four rigid side panels, a rigid roof panel, a plurality of pins, and a plurality of clips;
wherein each of the four side panels and the roof panel define peripheral apertures;
wherein each of the plurality of pins defines a respective aperture and handle portion;
arranging said side panels and roof panel such that each of the side panels is connected to two other side panels and the roof panel by two connections; and
forming the connections by extending each of the pins through one of the apertures in one of the panels and another of the apertures in another of the panels.

9. The method of claim 8, wherein said forming the connections includes inserting each of the clips into a respective one of the holes after said extending each of the pins through one of the apertures in one of the panels and another of the apertures in another of the panels.

10. The method of claim 9, further comprising attaching the four side panels to a floor.

11. The method of claim 10, wherein said attaching the four panels to a floor includes extending bolts through holes in each of said side panels and through holes in said floor.

12. The method of claim 11, further comprising engaging nuts on said bolts.

13. A kit of parts comprising:
four rigid side panels and a rigid roof panel;
each of the four side panels and the roof panel defining peripheral apertures; and
a plurality of pins;
said side panels and roof panel being positionable such that each of the side panels is connectable to two other side panels and the roof panel by two connections;
each of said connections being one of the pins extending through one of the apertures in one of the panels and another of the apertures in another of the panels.

14. The kit of parts of claim 13, further comprising a plurality of clips being insertable into holes formed in the pins.
